(19) United States
(12) Patent Application Publication
(10) Pub. No.: US 2026/0014582 A1
(43) Pub. Date: Jan. 15, 2026

(54) Dip Coating A Working Wire For A Biological Sensor

(71) Applicant: Allez Health Inc., Carlsbad, CA (US)

(72) Inventors: Robert James Boock, Carlsbad, CA (US); Sai Kit Wu, Irvine, CA (US)

(73) Assignee: Allez Health Inc., Carlsbad, CA (US)

(21) Appl. No.: 19/262,799

(22) Filed: Jul. 8, 2025

Related U.S. Application Data
(60) Provisional application No. 63/669,862, filed on Jul. 11, 2024.

(51) Int. Cl. B05C 3/10; B05C 3/04; B05C 21/00

(52) U.S. Cl. CPC B05C 3/10; B05C 3/04; B05C 21/00

(57) ABSTRACT

Systems and methods for dip coating a working wire of a metabolic sensor include a dipping station having a container and a fluid monitoring device. The fluid monitoring device is positioned to detect a fluid level of a dipping solution in the container. The systems and methods may include a heater, a conveyor between the dipping station and the heater, an optical measurement tool, and a robot positioned to move the wire-holding fixture between the conveyor, optical measurement tool and dipping station. The robot may be configured to dip the working wire into the dipping solution. A controller may be communication with the dipping station and the robot, wherein the controller is configured to control i) a motion of the robot for dipping the working wire into the container based on the fluid level and ii) a dipping parameter based on the diameter measured by the optical measurement tool.

### RELATED APPLICATIONS

This application claims priority to U.S. Provisional Patent Application No. 63/669,862, filed on Jul. 11, 2024, and entitled “Automated Dip Coating for a Biological Sensor”; the contents of which are incorporated by reference in full.

### BACKGROUND

Monitoring of glucose levels is critical for diabetes patients. Continuous glucose monitoring (CGM) sensors are a type of device in which glucose is measured from fluid sampled in an area just under the skin multiple times a day. CGM devices typically involve a small housing in which the electronics are located, and which is adhered to the patient's skin to be worn for a period of time. A small needle within the device delivers the subcutaneous sensor, which is often electrochemical.

The CGM sensor is typically temporarily adhered to the patient's skin with an adhesive pad, and the CGM sensor couples to a small housing in which electronics are located. The CGM sensor typically has a disposable applicator device that uses a small introducer needle to deliver the CGM sensor subcutaneously for the patient. Once the CGM sensor is in place, the applicator is discarded, and the electronics housing is attached to the sensor. Although the electronics housing is reusable and may be used for extended periods, the CGM sensor and applicator need to be replaced often, usually every few days.

Electrochemical glucose sensors operate by using electrodes which typically detect an amperometric signal caused by oxidation of enzymes during conversion of glucose to gluconolactone. The amperometric signal can then be correlated to a glucose concentration. The electrode typically includes an electrically conductive substrate and one or more membrane layers that produce electrical current in response to the amount of glucose present in the patient's body. The construction of these layers affects the performance of the device, such as the output readings and sensitivity. Manufacturing processes for CGM sensors can affect the accuracy and repeatability of fabricating these layers.

### SUMMARY

In some aspects, the techniques described herein relate to a system for dip coating a working wire of a metabolic sensor. The system includes an optical measurement tool configured to measure a diameter of a working wire in a wire-holding fixture; and a dipping station having a container and a fluid monitoring device. The fluid monitoring device is positioned to detect a fluid level of a dipping solution in the container. The system also includes a heater; a conveyor between the dipping station and the heater; and a robot positioned to move the wire-holding fixture between the conveyor, the optical measurement tool and the dipping station. The robot is configured to dip the working wire into the dipping solution. A controller is in communication with the dipping station and the robot, wherein the controller is configured to control i) a motion of the robot for dipping the working wire into the container based on the fluid level and ii) a dipping parameter based on the diameter measured by the optical measurement tool.

In some aspects, the techniques described herein relate to a method for dip coating a working wire of a metabolic sensor. The method includes measuring, by an optical measurement tool, a diameter of a working wire in a wire-holding fixture; monitoring, by a fluid monitoring device, a fluid level of a dipping solution in a container of a dipping station; dipping, by a robot, the working wire into the dipping solution; transporting, by a conveyor, the wire-holding fixture from the dipping station to a heater; and controlling, by a controller: i) a motion of the robot for dipping the working wire into the container based on the fluid level, and ii) a dipping parameter based on the diameter measured by the optical measurement tool.

In some aspects, the techniques described herein relate to a system for dip coating a working wire of a metabolic sensor. The system includes a dipping station having a container and a fluid monitoring device, wherein the fluid monitoring device is positioned to detect a fluid level of a dipping solution in the container; a robot positioned to dip a working wire into the dipping solution; and a controller in communication with the dipping station and the robot, wherein the controller is configured to control a motion of the robot for dipping the working wire into the dipping solution based on the fluid level.

In some aspects, the techniques described herein relate to a system for coating a working wire of a metabolic sensor. The system includes a dipping container shaped as a horizontal tank and configured and to hold a dipping solution; a continuous feed wire source positioned to feed a working wire across a top surface of the dipping solution; and an optical measurement tool configured to measure a diameter of the working wire after exiting the dipping container.

### BRIEF DESCRIPTION OF THE DRAWINGS

FIG. 1 is a not-to-scale cross-sectional view of a working wire, in accordance with some aspects.

FIG. 2 is an isometric view of a wire-holding fixture and a container for a dipping solution, in accordance with some aspects.

FIGS. 3A-3B show a first side and second side of a wire-holding fixture, in accordance with some aspects.

FIG. 4 is a schematic plan view of a system for dip coating a material onto a working wire by dipping, in accordance with some aspects

FIG. 5 is a top perspective view of cars for a conveyor, in accordance with some aspects.

FIGS. 6A-6B are views of a staging area of a system for dipping a working wire, in accordance with some aspects.

FIGS. 7A-7B are perspective views of storage units for holding fixtures, in accordance with some aspects.

FIGS. 8A-8B are views, of a dipping station, in accordance with some aspects.

FIG. 9 is a perspective view of an optical measurement tool, in accordance with some aspects.

FIGS. 10A-10B are views of another configuration of jaws, in accordance with some aspects.

FIGS. 11A-11C show views of a heater for curing working wires, in accordance with some aspects.

FIG. 12A is a longitudinal side view of a dipping station for a continuous manufacturing dipping process, in accordance with some aspects.

FIG. 12B shows an exploded view of the dipping container of FIG. 12A, in accordance with some aspects.

FIG. 13 is a schematic plan view of a manufacturing system for performing dip coating of a working wire in a continuous manner, in accordance with some aspects.

FIGS. 14A-14B are flowcharts of methods of dip coating a working wire, in accordance with some aspects.

FIG. 15 is a flowchart of a method for dip coating a working wire in a continuous manner, in accordance with some aspects.

FIG. 16 is a simplified schematic diagram of an example computer processor for use in the controllers of the methods and systems, in accordance with some aspects.

### DETAILED DESCRIPTION

Systems and processes for manufacturing working wires for a continuous biological sensor are described herein, that enable manufacturing scalability and improve accuracy and efficiency compared to known art. The continuous biological sensor may be, for example, a continuous glucose monitor, in which the working wire includes an enzyme layer to detect the level of glucose in a patient's blood. In other examples, the biological sensor can be a metabolic sensor for measuring other metabolic characteristics such as lactate, ketone or fatty acids. The sensor uses a working wire (i.e., an electrode for the sensor) that has a core and several concentrically formed membrane layers on the core.

The systems and processes described herein enable coating of membrane layers of a sensor for a biological sensor (such as a glucose sensor for a continuous glucose monitoring device or a lactate sensor for a continuous lactate monitoring device) in an efficient and accurate manner, using careful control and feedback and with automated features. The membrane layers may be for an enzyme layer of a glucose sensor, for example, which may be formed by a dipping process to coat the membrane layers onto a working wire, such as with an aqueous dipping compound. The systems and processes uniquely provide mass production of biological sensors in a repeatable manner and furthermore provide tracking of manufacturing parameters for each individual wire that is produced. This traceability is advantageous not only for keeping manufacturing records but also enables precise calibration of each individual sensor by knowing the process conditions that were used for fabricating each particular sensor. As an example, the dip coating conditions for an individual sensor wire can be used to control the sensing layer thicknesses and consequently the sensitivity of the final sensor. This ability to predict the sensor's behavior over time can reduce or eliminate the need for local calibration by the patient using finger stick monitoring, as required with conventional CGM sensors. The systems and methods described herein uniquely involve careful real-time monitoring and feedback of parameters in the production line such as fluid levels in the dipping station and diameters of working wires following each dipping cycle. Monitoring of these characteristics increases the quality of the working wires produced while also improving efficiency of the production line.

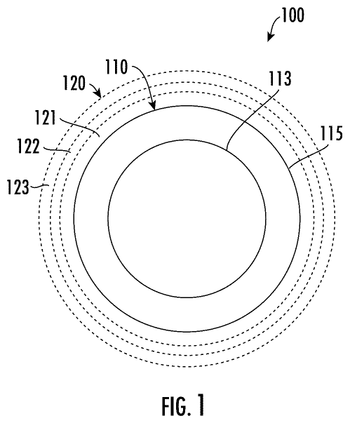

Referring to FIG. 1, a cross-sectional view of a working wire 100 is illustrated in accordance with some aspects. In this example, the working wire 100 is an elongated wire having a circular cross-section. It will be understood that other cross-sections may be used, such as square, rectangular, triangular, or other geometric shapes. Furthermore, the working wire 100 may take other forms, such as a plate or ribbon. The working wire 100 is used as a working electrode of a continuous biological sensor, such as a working electrode of a continuous glucose monitor.

In the illustrated example, the working wire 100 has a substrate 110 onto which biological membranes 120 may be disposed. In one example as illustrated, the biological membranes 120 include an interference membrane 121 (which may also be referred to as an interference layer) on the substrate 110, an enzyme membrane 122 (i.e., an enzyme layer) on the interference membrane 121, and a glucose limiting membrane 123 (i.e., a glucose limiting layer) on the enzyme membrane 122. In some aspects, a protective or outer coating may be optionally applied over the glucose limiting membrane 123. In cases where the working wire 100 is for a lactate sensor, glucose limiting membrane 123 may be instead configured as a lactate limiting layer. Although the working wire 100 is illustrated as having three biological membranes 120, it will be understood that the biological membranes 120 may be more or fewer in number.

The substrate 110 may be comprised of a core 113 with an outer layer 115. In the example of FIG. 1, the core 113 is an elongated wire that is dense, ductile, very hard, easily fabricated, highly conductive of heat and electricity, and may also be resistant to corrosion. Example materials for core 113 include tantalum (Ta), carbon (C), or cobalt-chromium (Co—Cr) alloys. The core 113 may have the outer layer 115, such as of platinum (Pt), deposited or applied using an electroplating process. It will be understood that other processes may be used for applying the outer layer 115 to the core 113. For a glucose monitor, the platinum outer layer facilitates a reaction where hydrogen peroxide reacts to produce water and hydrogen ions, and two electrons are generated. The electrons are drawn into the platinum by a bias voltage placed across the platinum wire and a reference electrode. In this way, the magnitude of the electrical current flowing in the platinum is intended to be related to the number of hydrogen peroxide reactions, which in turn is proportional to the number of oxidized glucose molecules. A measurement of the electrical current on the platinum wire can thereby be associated with a particular level of glucose in the patient's blood or interstitial fluid (ISF) (a biological fluid in the patient's body that contains diverse biomarkers and analytes and is similar to blood composition).

The core 113, outer layer 115, interference membrane 121, and enzyme membrane 122 form key aspects of the working wire 100. Other layers and/or membranes may be added depending upon the biological substance being tested for, and application-specific requirements. In some cases, the core 113 may have an inner core portion (not shown). For example, if the substrate (core 113) is made from tantalum, an inner core of titanium (Ti) or titanium alloy may be included to provide additional strength and straightness for the working wire 100.

One or more membranes (i.e., layers) may be provided over the enzyme membrane 122. For example, the glucose limiting membrane 123 may be layered on top of the enzyme membrane 122. This glucose limiting membrane 123 may limit the number of glucose molecules that can pass through the glucose limiting membrane 123 and into the enzyme membrane 122. The glucose limiting membrane 123 can be configured as described in U.S. Pat. No. 11,576,595, entitled “Enhanced Sensor for a Continuous Biological Monitor,” which is owned by the assignee of the present disclosure and is incorporated herein by reference as if set forth in its entirety. In some cases, the addition of the glucose limiting membrane 123 has been shown to enable better performance of the overall working wire 100.

The interference membrane 121 is applied over the outer layer 115 of the substrate 110. The interference membrane 121 may be disposed between the enzyme membrane 122 and the outer layer 115. This interference membrane 121 is constructed to fully wrap the outer layer 115, thereby protecting the outer layer 115 from, or mitigating, oxidation effects. The interference membrane 121 is also constructed to substantially restrict the passage of larger molecules, such as acetaminophen, to reduce contaminants that can reach the platinum of the outer layer 115 and skew results. Further, the interference membrane 121 may pass a controlled level of hydrogen peroxide (H₂O₂) from the enzyme membrane 122 to the platinum outer layer 115. Compositions for the interference membrane 121 and the enzyme membrane 122 may be as described in U.S. patent application Ser. No. 19/047,285, entitled “Continuous Biological Sensor with Enzyme Immobilization,” and U.S. patent application Ser. No. 17/449,380, entitled “In-Vivo Glucose Specific Sensor,” which are owned by the assignee of the present disclosure and incorporated herein by reference as if set forth in their entirety.

The interference membrane 121 may be electrodeposited onto the electrical conducting wire (i.e., substrate 110) in a very consistent and conformal way, thus reducing manufacturing costs as well as providing a more controllable and repeatable layer formation. The interference membrane 121 is formulated to be nonconducting of electrons but will pass negative ions at a preselected rate. Further, the interference membrane 121 may be formulated to be permselective (i.e., semipermeable) for particular molecules. In one example, the interference membrane 121 is formulated and deposited in a way to restrict the passage of larger molecules, which may act as contaminants to degrade the conducting layer (i.e., substrate 110), or that may interfere with the electrical detection and transmission processes.

In some examples, the enzyme membrane 122 (i.e., enzyme layer) is made from an aqueous emulsion of a polyurethane and glucose oxidase (GOx) blend, which is applied (e.g., by dipping) to the working wire 100 and cured as described in U.S. Pat. No. 11,013,438, entitled “Enhanced Enzyme Membrane for a Working Electrode of a Continuous Biological Sensor” which is owned by the assignee of the present disclosure and is hereby incorporated by reference in its entirety. This enzyme membrane 122 has better stability and full entrapment of GOx, a more even dispersion, and enables higher loading of GOx and better overall sensor sensitivity compared to conventional glucose sensors. In one aspect, the enzyme membrane 122 may be made by making an aqueous polyurethane emulsion; making an acrylic polyol emulsion; mixing the polyurethane emulsion and the acrylic polyol emulsion to make a base emulsion; adding an enzyme to the base emulsion to create an enzyme/base emulsion dispersion, the enzyme being selected according to a biological function to be monitored; applying the enzyme/base emulsion dispersion to the working electrode (e.g., by dipping); and curing the applied enzyme/base emulsion dispersion. In another aspect, the enzyme membrane 122 may be made by making an aqueous silicone dispersion; making an acrylic polyol emulsion; mixing the silicone emulsion and the acrylic polyol emulsion to make a base emulsion; adding an enzyme to the base emulsion to create an enzyme/base emulsion dispersion, the enzyme being selected according to a biological function to be monitored; applying the enzyme/base emulsion dispersion to the working electrode (e.g., by dipping); and curing the applied enzyme/base emulsion dispersion.

In some examples, the enzyme membrane 122 is made from an aqueous emulsion of a polyurethane and GOx blend, which is applied (e.g., by dipping) to the working wire and cured as described in U.S. Pat. No. 11,134,874, entitled “Enhanced Carbon-Enzyme Membrane for a Working Electrode of a Continuous Biological Sensor” which is owned by the assignee of the present disclosure and is hereby incorporated by reference in its entirety. In one aspect, the enzyme membrane 122 may be made by making an aqueous polyurethane emulsion; making an acrylic polyol emulsion; mixing the polyurethane emulsion and the acrylic polyol emulsion to make a base emulsion; adding an enzyme to the base emulsion, the enzyme being selected according to a biological function to be monitored; adding a carbon material to the base emulsion; applying the base emulsion having the enzyme and the carbon material to the working electrode (e.g., by dipping); curing the applied base emulsion to form the carbon-enzyme layer (i.e., carbon-enzyme membrane); and wherein the carbon-enzyme layer is electrically conductive and facilitates the generation of either peroxide or electrons within the carbon-enzyme layer responsive to reacting the enzyme with a target biologic. In another aspect, the enzyme membrane 122 may be made by making an aqueous silicone dispersion; making an acrylic polyol emulsion; mixing the silicone dispersion and the acrylic polyol emulsion to make a base emulsion; adding an enzyme to the base emulsion, the enzyme being selected according to a biological function to be monitored; adding a carbon material to the base emulsion; applying the base emulsion having the enzyme and the carbon material to the working electrode (e.g., by dipping); curing the applied base emulsion to form the carbon-enzyme layer; and wherein the carbon-enzyme layer is electrically conductive and facilitates the generation of either peroxide or electrons within the carbon-enzyme layer responsive to reacting the enzyme with a target biologic.

In some examples, the enzyme membrane 122 includes an enzyme immobilization network as described in U.S. patent application Ser. No. 19/047,285, entitled “Continuous Biological Sensor with Enzyme Immobilization.” This enzyme immobilization network stabilizes the sensitivity of the sensor for an extended number of days, thereby increasing its useful life, and reducing the need for algorithmic corrections or local patient calibrations. The enzyme immobilization network can increase the stabilization after sterilization with a sterilization gas such as EtO. The enzyme immobilization network acts as an immobilization network for the metabolic biological enzyme, such as glucose oxidase enzymes (GOx). To create the enzyme immobilization network, polymers or proteins are stabilized with the enzymes using crosslinking agents, such as polymeric or non-polymeric crosslinking agents. Once the sensor has been manufactured using such an enzyme immobilization network, the sensor exhibits dramatically improved stability and exhibits increased stability after gas sterilization. In a specific example, the enzyme membrane 122 includes enzymes (e.g., GOx), an immobilization matrix, and a polymeric crosslinking agent and a non-polymeric crosslinking agent crosslinking the enzymes and the immobilization matrix creating an enzyme immobilization network, wherein the polymeric crosslinking agent and the non-polymeric crosslinking agent is a combination of polyethylene glycol (PEG) dialdehyde and glutaraldehyde.

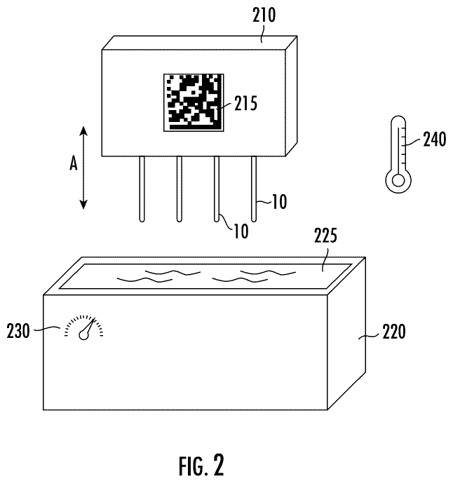

For any of the coatings (e.g., aqueous coatings) used to form a membrane layer (e.g., enzyme membrane 122, interference membrane 121, or glucose limiting membrane 123) on the continuous biological sensor, a dipping process may be used. An example of a dipping station that may be utilized in the present disclosure is described in FIG. 2.

FIG. 2 is an isometric view of a wire-holding fixture 210 and a container 220 (e.g., tub, beaker, bowl) for holding a dipping solution, in accordance with some aspects. Multiple working wires 10 are mounted into the wire-holding fixture 210, where the working wires 10 may be uncoated or may have some but not all the membrane layers coated onto it. For example, working wires 10 may consist of only the substrate 110 (of FIG. 1), or may be in the process of dipping layers of the interference membrane 121, and enzyme membrane 122, or glucose limiting membrane 123 onto the substrate 110. The wire-holding fixture 210 is a holder, depicted as a block in this illustration, for transporting the working wires 10 through a coating process (dipping in this disclosure) during manufacturing. The wire-holding fixture 210 may also be referred to as a carrier or tray. The working wires 10 may be secured into the wire-holding fixture 210 by, for example, clamps, spring-loaded clips, set screws, adhesive fasteners, or other mechanisms. The wire-holding fixture 210 may include an identifier code 215 such as a scannable code (e.g., bar code or quick response “QR” code) for tracking the progress of the particular wire-holding fixture 210 during manufacturing. The identifier code 215 may be other types of identifying labels such as a radiofrequency identification (RFID) tag, in which an RFID reader is used to read the RFID tag. Four working wires 10 are shown in this example, but the wire-holding fixture 210 may be configured to hold more or fewer working wires in other examples. The working wires 10 are mounted in a single row in this example, spaced apart and extending from an edge of the wire-holding fixture 210 so that each one can be measured individually from various angles. In other examples the wires may be arranged in other fashions, such as in more than one row, aligned or staggered from each other, as long as sufficient space is provided between the working wires to enable each wire to be measured separately.

The container 220 holds a coating solution 225, such as a polymer or polymer mixture for the dip coating. The working wires 10 mounted on the wire-holding fixture 210 are submerged into the coating solution 225 to create a desired membrane on the wire. For example, the dipping process may be used to create enzyme membrane 122 or another membrane of the biological sensor (e.g., glucose sensor or lactate sensor). Each membrane may require several dipping cycles (i.e., multiple coating iterations) to build up a desired thickness of the full membrane. For example, a target thickness for a glucose enzyme membrane may be approximately 2 microns to 3 microns, such as 2.5 microns±0.5 microns or 2.5 microns±0.2 microns. A target thickness for a lactate enzyme membrane may be approximately 5 microns to 7 microns, such as 6.0 microns±0.5 microns.

The container 220 may include one or more sensors 230 that monitor aspects of the coating solution such as viscosity or solution temperature. The system may also include environmental sensors 240 to monitor aspects of the ambient environment such as air temperature, relative humidity and airflow velocity. Aspects of the present disclosure beneficially utilize these environmental sensors to provide input to a controller to adjust dipping parameters during manufacturing, as described in U.S. patent application Ser. No. 17/659,267, entitled “Coating a Working Wire for a Continuous Biological Sensor” which is owned by the assignee of the present disclosure and is hereby incorporated by reference in its entirety. In this manner, adjustments may be automatically made by a controller (described in later sections) to account for process variations that are extremely difficult to control manually. For example, changes in solution properties during the manufacturing process due to environmental factors can advantageously be compensated for in real-time. Lot-to-lot variations in solution viscosity or solids content can further affect how the environmental factors affect the solution. These impacts can also be accounted for by the present systems and methods.

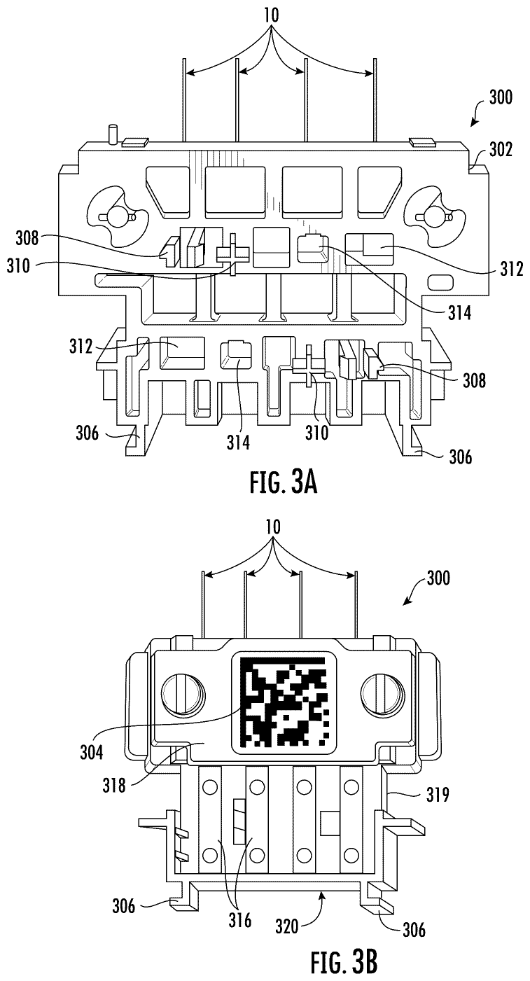

FIGS. 3A-3B show a first side and second side of a wire-holding fixture 300, in accordance with some aspects. In FIG. 3A, four working wires 10 are shown mounted into a body 302 of the wire-holding fixture 300. In other examples, the wire-holding fixture 300 may be configured to hold more or fewer working wires during manufacturing, such as 1 to 10, or 2 to 8, or 2 to 6, or other appropriate number or range. The wire-holding fixture 300 has L-shaped feet 306 to enable it to stand, be fixed in place, or be hung upside down as needed. Snapping tabs 308 are also included, extending outward from the face of the wire-holding fixture 300, to enable two wire-holding fixtures 300 to be snapped together (e.g., in pairs, back-to-back) and transported together during manufacturing. In this illustration, two sets of snapping tabs 308 and alignment posts 310 are positioned diagonally from each other on the wire-holding fixture 300. When two wire-holding fixtures 300 are placed with the same sides facing each other, a snapping tab 308 on one wire-holding fixture 300 fits into a tab hole 312 on the other wire-holding fixture 300 that it is being attached to (i.e., a mating fixture), and the alignment post 310 fits into an alignment hole 314 of the mating fixture. The diagonal positioning of the alignment posts 310 on the wire-holding fixtures 300 helps ensure that the wire-holding fixtures 300 are properly aligned in all axes, and the snapping tabs 308 lock the wire-holding fixtures 300 together. Being able to thus “gang” or attach wire-holding fixtures 300 together allows more than one wire-holding fixture 300 to be moved together at a time (e.g., by a robot), which increases manufacturing speed. Various features of the wire-holding fixture 300 such as wings, indentations, grooves, and the like, may be used as gripping features for a robot to grab. For example, recess 319 may be used as an area for robotic jaws to hold the wire-holding fixture 300. The features may be configured to provide proper alignment in the robot and when inserted into a dipping station (e.g., in x-y-z linear and rotational directions), since misalignment can affect the uniformity and/or concentricity of the coating on the working wire 10.

In FIG. 3B, the opposite face of the wire-holding fixture 300 is shown. An identifier code 304 (e.g., QR code or other identifier/scannable code) is included for tracking the wire-holding fixture 300 during manufacturing as described herein. In this example, the QR code is a sticker that is affixed to a plate 318 (e.g., metal) that is attached to the body 302 (e.g., plastic). Additionally, metal strips 316 are shown attached to the body 302. One metal strip 316 is present for and electrically connected to a corresponding working wire 10 in the wire-holding fixture 300. The metal strips 316 provide an electrical connection between the working wire 10 and a terminal point on a bottom side 320 the wire-holding fixture 300 for various manufacturing process steps, such as electropolymerization and electrical testing (e.g., calibration). In other examples, the metal strips 316 may be configured as a wire, electrically conductive coating, or other electrical conduit between the working wire 10 and the terminal point on the bottom side 320 of the wire-holding fixture 300.

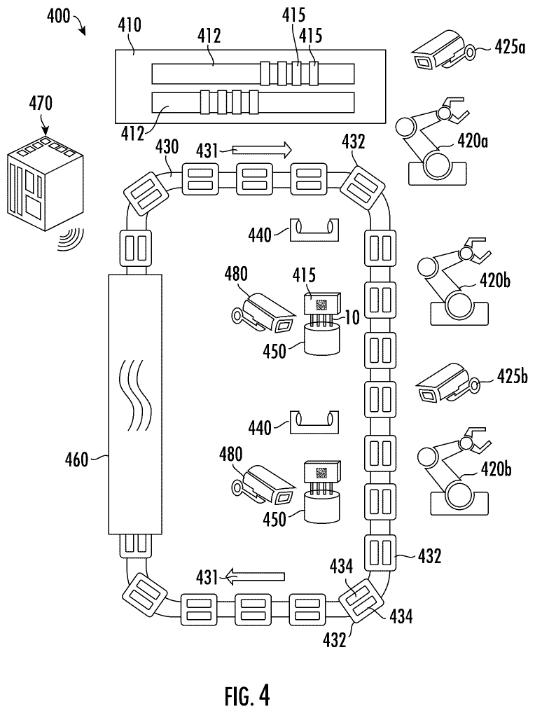

FIG. 4 is a schematic plan view of a system 400 for dip coating a material onto a working wire 10 by dipping, in accordance with some aspects. A staging area 410 (i.e., holding or storage region) has racks 412 for holding wire-holding fixtures 415 (e.g., wire-holding fixtures 300 that were described in FIGS. 3A-3B). A first robot 420a is positioned to move the wire-holding fixtures 415 from the staging area 410 to a conveyor 430. The conveyor 430 transports the working wires 10 on the wire-holding fixtures 415 during manufacturing. The conveyor 430 may include, for example, a rail or track. The rail or track may be driven by a motor to move the conveyor 430 itself. Alternatively, a motor may be included on cars 432 on conveyor 430 to move the cars 432 along the conveyor 430. One or more additional robots 420b are positioned near the conveyor 430 (e.g., adjacent to within range of the motion of a robotic arm on robot 420b) to move the wire-holding fixtures 415 between the conveyor 430, an optical measurement tool 440, and a dipping station 450. One or more optical measurement tools 440 and dipping station 450 may be present in the system 400, where two of each are shown in this example.

The robots 420a-b may be, for example, a robotic mechanism, such as a 3-axis robot or 6-axis robot with a robotic manipulation arm. In this example, robot 420a retrieves wire-holding fixtures 415 from the racks 412 and places the fixtures in cars 432 that move along the conveyor 430. The cars 432 may be, for example, blocks with slots 434 that hold the fixtures, where each car 432 has two slots 434 for holding two wire-holding fixtures 415 in this example. The conveyor 430 forms a route between dipping station 450 (or multiple dipping stations if present) and a heater 460. The heater 460 supplies heat for curing the coating on the working wire 10, where the coating is formed by dipping the working wire 10 in a dipping solution (e.g., coating solution 225 of FIG. 2, which may be an aqueous-based solution) at dipping station 450. The route may be closed loop as shown in FIG. 4, where the conveyor 430 forms a continuous loop between the dipping station 450 and the heater 460 so that the wire-holding fixtures 415 repeat the path of dipping and heating. In other examples, the route may be open loop where the desired numbers of dipping stations 450 and heaters 460 are placed along the route, and the wire-holding fixtures 415 encounter each station only once before reaching a final endpoint. In open loop configurations, wire-holding fixtures 415 may be transported back to the beginning of the conveyor 430 using alternative mechanisms such as a separate robot, an additional conveyor, or manual handling. In some implementations, the dipping station(s) 450 may be positioned near the entrance of heater 460 so that the coating can be cured as soon as possible after dipping to avoid the coating from running/dripping off the working wires.

A reader 425a-b, which may be an optical device (e.g., camera, laser scanner, or RFID reader if RFID tags are used) is installed at one or more locations-such as on a robotic arm of one of the robots 420a-b, in the staging area 410, or near the conveyor 430-to track the location of wire-holding fixtures 415. The reader 425a-b (e.g., optical device) is positioned to read an identifier code 304 (FIG. 3A, e.g., scan a scannable code such as a QR code) on the wire-holding fixtures 415. The reader 425a-b is in communication with a computer processor (controller 470) that stores manufacturing data corresponding to the working wire using the identifier code. The reader 425a-b (e.g., optical device) enables manufacturing data to be recorded for each working wire 10 by tracking information, such as which wire-holding fixture 415 is being dipped or heated (i.e., cured), and/or what parameters were used for each individual wire-holding fixture 415 at each operation.

In this illustration, reader 425a is positioned near the staging area 410 to track which wire-holding fixture 415 is being moved to the dipping process. Reader 425b is near the dipping stations 450 to identify which wire-holding fixtures 415 are being dipped so that the system 400 (e.g., via a computer processor or controller 470 in communication with the system) can instruct the system on what dipping parameters to use for that particular wire-holding fixture 415. The controller 470 may also inform each dipping station 450 whether the wire-holding fixture 415 has completed sufficient dipping cycles such that a target thickness has been reached. The controller 470 may be in communication with one or more of the dipping stations 450, the robots 420a-b, and/or the readers 425a-b. The controller 470 may be in communication through physical cables and/or by wireless connections. The controller 470 may be a computer processor at the location of the system 400 and/or may comprise a cloud server remote from the system 400. One controller 470 may be used for the entire system, or multiple controllers 470 may be used throughout the system.

The system 400 of FIG. 4 includes one or more dipping stations 450 for applying a coating to a working wire 10, where two dipping stations 450 are shown in this illustration. Multiple dipping stations may be included to feed more wire-holding fixtures 415 from the dipping stations 450 to the heater 460. A robot 420b is included at each dipping station 450 to load and unload the wire-holding fixture 415 between the conveyor 430 and the dipping station 450. In some cases, the robot 420b is configured to dip working wire(s) of the wire-holding fixture 415 into the dipping solution at the dipping station 450. That is, robot 420b moves a wire-holding fixture 415 from the conveyor 430 to the dipping station 450, may dip and withdraw the working wires from the dipping solution, and then place the wire-holding fixture 415 back onto the conveyor 430. Robot 420b may be, for example, a 6-axis robot. Robot 420b may be configured to respond to tracking information from controller 470, which monitors which cars 432 contain wire-holding fixtures 415. For example, for two robots 420b present in system 400, each one may be programmed to load or unload wire-holding fixtures 415 in every other car 432. If three robots 420b are present, each one may be programmed to load or unload wire-holding fixtures 415 in every third car. In other examples, the robots 420b may be programmed to load a wire-holding fixture 415 into the nearest passing car 432 that is empty, after completing the dipping process at a dipping station 450.

A fluid monitor 480 may be included at or near (e.g., within the fluid monitor's visual capability range if the fluid monitor 480 is a camera) the dipping station 450 to monitor a fluid level of a dipping solution in a container (e.g., beaker) at the dipping station 450. The fluid monitor 480 is illustrated as an optical device (e.g., a camera) in this example but may be another type of fluid monitor as shall be described below. The fluid monitor 480 may beneficially track the volume of dipping solution at the dipping station 450 to ensure proper dipping of the working wires and to alert the system when replenishment of the dipping solution is needed. The volume may be monitored by visually monitoring the level of a top surface of the dipping solution. In addition to or instead of monitoring a fluid level of dipping solution, fluid monitor 480 may also beneficially monitor the condition of a surface of the dipping solution to implement a proper rate of stirring to keep components of the dipping solution properly mixed and to prevent a skin from forming on the dipping solution.

An optical measurement tool 440 may be included along a route of the conveyor 430. The optical measurement tool 440 is configured to measure a diameter of the working wire and provide feedback to the dipping station 450, via the controller 470. The controller 470 may use a dipping algorithm to determine appropriate dipping parameters for dipping the next layer, or to assess whether the desired membrane thickness has been achieved on the working wire. For example, the diameter of the working wire can be measured prior to dipping the wire, to check the coating thickness resulting from the previously applied layer (e.g., after curing). A dipping parameter at the dipping station 450 may then be determined by the system 400 according to the diameter measured by the optical measurement tool 440. In some aspects, the robot 420b is configured to dip the working wire into the dipping solution, the controller 470 is in communication with the dipping station 450 and the robot 420b, and the controller 470 is configured to control a dipping parameter (e.g., a withdrawal speed for the robot 420b extracting the working wire out of the dipping solution) based on the diameter measured by the optical measurement tool 440.

A heater 460 for curing the coating on the working wires is also included in the system 400, where the conveyor 430 extends between the dipping station(s) 450 and the heater 460 as indicated by the arrows 431 in FIG. 4. The heater 460 may be, for example, a heat tunnel that the conveyor 430 passes through, or may be heat lamps positioned above and/or beside the conveyor route. After the wire-holding fixtures 415 exit from the heater 460, they may be retrieved by one of the robots 420b for another dipping cycle if measurements from the optical measurement tool 440 indicate that the desired total layer thickness has not yet been achieved for the wires in that fixture.

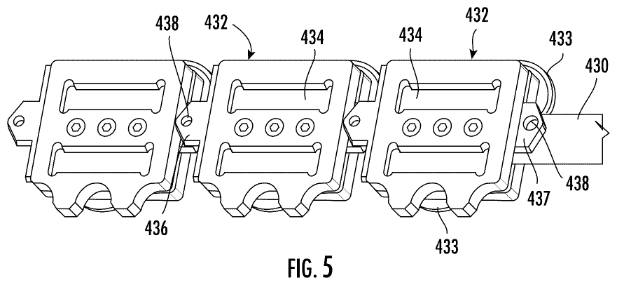

FIG. 5 is a top perspective view of two cars 432 for the conveyor 430, in accordance with some aspects. The conveyor 430 is configured as a flat track in this illustration, where horizontal wheels 433 on each car 432 straddle the track and roll along the track. In other cases, the cars 432 may have vertical wheels that roll on top of and along grooves in the track, or the cars 432 may be fixed onto the conveyor and the conveyor itself moves (e.g., the conveyor configured as a chain link). In this example, the cars 432 have an upper hitch 436 on one end and a lower hitch 437 on an opposite end. The cars 432 may be coupled together by inserting a pin into the holes 438 of upper hitch 436 and lower hitch 437 of adjacent cars. Each car 432 has slots 434 shaped to receive the wire-holding fixtures 300. Two slots 434 per car are shown in this example. In other examples, one slot 434 or more than two slots may be included.

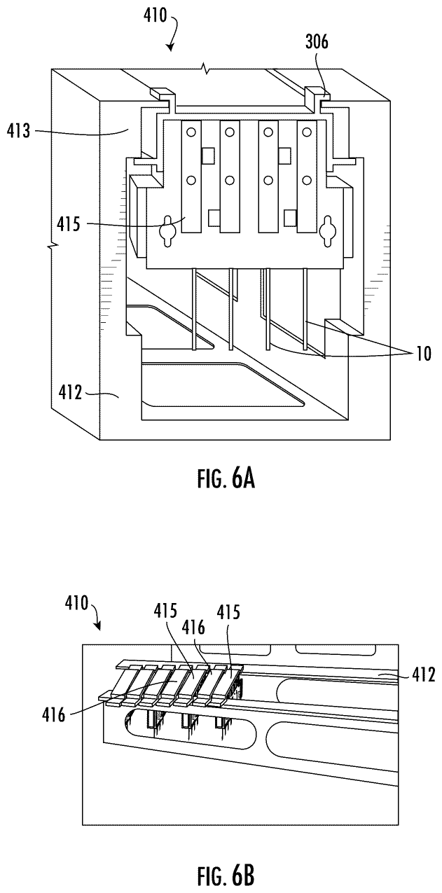

FIGS. 6A-6B are a front view and a side perspective view, respectively of a staging area 410 of the system 400 for dipping a working wire, in accordance with some aspects. Racks 412 are in the staging area 410, with wire-holding fixtures 415 (e.g., wire-holding fixtures 300) in the racks 412. In some cases, two or more racks 412 may be present in the staging area 410, where some racks may be used for input (i.e., for wire-holding fixtures to be dipped) and the other racks may be used for output (i.e., for wire-holding fixtures after dipping has been completed). The wire-holding fixtures 415 are oriented upside down in FIGS. 6A-6B compared to FIGS. 3A-3B, such that the working wires 10 extend downward from the wire-holding fixtures 415. The feet 306 of the wire-holding fixture in FIG. 6A rest along upper rails 413 of the rack 412 so that multiple wire-holding fixtures 415 can be slid onto and held in the rack 412 as shown in FIG. 6B. During manufacturing, multiple wire-holding fixtures 415 may be arranged on the rack 412. FIG. 6B is a side view of the rack, where spacers 416 are inserted between wire-holding fixtures 415 in this illustration. The spacers 416 are shaped similarly to the wire-holding fixtures 415 but are not configured to hold any working wires. In other words, the spacers 416 are dummy fixtures that serve to separate the working wires 10 of adjacent wire-holding fixtures 415 from each other, to help prevent damage to the working wires 10. A robot 402a or 402b (FIG. 4) can retrieve wire-holding fixtures 415 from the rack 412 to move the wire-holding fixtures 415 through the dip coating process.

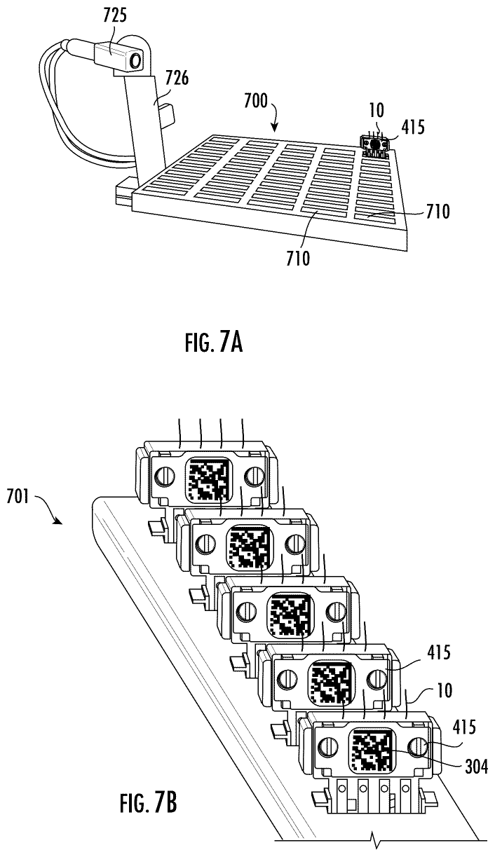

FIG. 7A shows a perspective view of a storage unit 700 for holding wire-holding fixtures 415, in accordance with some aspects. Storage unit 700 may be located near a dipping station 450 of the system 400, and/or at other locations in the system 400 for temporarily holding wire-holding fixtures 415. The storage unit 700 has a plurality of slots 710 for wire-holding fixtures 415 to be placed into before or after dipping (e.g., while being moved between the staging area and the dipping area), or while waiting for other processing such as measuring diameters of working wires 10. The wire-holding fixtures 415 are positioned with the working wires 10 vertically upward, as also shown in the smaller storage unit 701 of FIG. 7B. The storage units 700 may be configured with various numbers of slots 710 depending on the quantity of working wires being processed during a manufacturing shift. The storage units 700 may be configured as a two-dimensional array as in FIG. 7A (e.g., five by eleven slots in this illustration), or a one-dimensional array as in FIG. 7B (e.g., one row of slots).

A reader 725, depicted in FIG. 7A as an optical device, may be included at or near (e.g., within the optical device's visual viewing range) the storage unit 700 to monitor which wire-holding fixtures 415 are being stored. The optical device (reader 725) can be a camera, laser scanner, or other device capable of reading a QR code or other scannable identifier on the wire-holding fixtures. In the example of FIG. 7A, the optical device (reader 725) is coupled to the storage unit 700 by an arm 726. When a robot (e.g., robot 420b of FIG. 4) picks up a wire-holding fixture 415 from the storage unit 700 or inserts a wire-holding fixture 415 into the storage unit, the robot can pass the wire-holding fixture 415 in front of the reader 725 to scan the identifier code 304 (FIG. 3B). Controller 470 of FIG. 4 can use the identifier code 304 to notify the system 400 that the particular wire-holding fixture 415 is being processed, and the system 400 can obtain manufacturing parameters (e.g., dipping parameters) and/or data (e.g., diameter measurements from previous dipping cycles) associated with the working wires 10 in that individual wire-holding fixture 415.

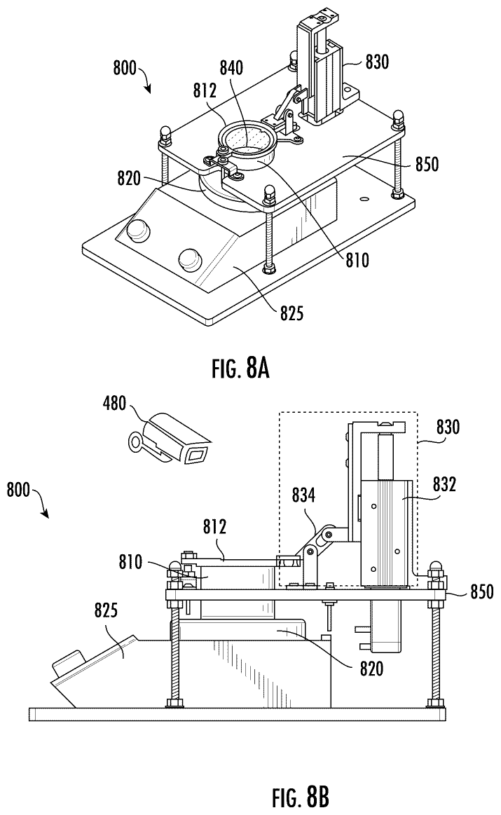

FIGS. 8A-8B are isometric and side views, respectively, of a dipping station 800, in accordance with some aspects. Dipping station 800 may be, for example, the dipping station 450 of FIG. 4. Dipping station 800 includes a container 810, a lid 812 coupled to container 810 (e.g., by a hinge), an optional hot plate/stir plate 820, and an optional actuator 830 coupled to lid 812. Container 810 is configured to hold a dipping solution 840 and is configured as a cylindrical beaker in this illustration. In other examples, the container 810 may be other shapes such as the rectangular trough shown in FIG. 2, or a tub, dish, bowl or other type of container. The dipping solution 840 may be, for example, a solution for forming an interference membrane 121, enzyme membrane 122, or glucose limiting membrane 123 for the working wire 100 of a biological sensor in FIG. 1. In some cases, dipping solution 840 is an enzyme solution which may be an aqueous emulsion as described herein. The container 810 may be seated in a cutout of a plate 850, the cutout having a shape corresponding to the shape of the container 810 (e.g., a circle in this example), to hold the container 810 in place.

The dipping station 800 may also include a hot plate/stir plate 820 (e.g., a hot plate stirrer, magnetic stirrer hot plate, hot plate without stirring, or stir plate without heating). The hot plate/stir plate 820 heats the dipping solution 840 to a desired temperature and/or includes a magnetic stirring capability (e.g., to use with a magnetic stirring bar in the container 810). The hot plate/stir plate 820 (e.g., a stirring plate) is below the container 810. Stirring can promote a uniform distribution of polymers in the dipping solution 840, to prevent a concentration gradient through the depth of the dipping solution as the material is deposited on the working wires 10 near the surface of the solution. In some aspects, controller 470 (FIG. 4) is configured to control a stirring rate of the stirring plate, such as by communicating with control box 825 of hot plate/stir plate 820. As an example, controller 470 may be programmed to maintain a target temperature of dipping solution 840, and/or stir the dipping solution 840 at particular intervals.

Actuator 830 is operatively coupled to the lid 812. In this example, the actuator 830 includes a slide rail 832 coupled to the lid 812 via a linkage arm 834. A controller (e.g., controller 470 of FIG. 4) is configured to actuate the actuator 830 to move the lid 812 between a closed position and an open position, the lid 812 being in the closed position (as shown in FIGS. 8A-8B) when the dipping station is not in use. The controller may be in communication with robots 420a-b of system 400 to be informed of when a wire-holding fixture is being processed at dipping station 800. Having the lid 812 opened or closed by the controller when needed beneficially helps preserve the dipping solution 840, such as by reducing evaporation of a solvent in the dipping solution 840, maintaining the temperature of the dipping solution 840, and/or helping to avoid contaminants from dropping into the container 810. As a result, the dipping process can be performed more cost-effectively and with higher quality than having the lid 812 of container 810 open all the time.

Also shown in FIG. 8B is fluid monitor 480 to track the fluid level of the dipping solution 840 in the container 810, in some cases. In this example, the fluid monitor 480 is a camera that can optically monitor the fluid level. For example, a starting line of the fluid level may be marked on the container 810, and the fluid monitor 480 can provide feedback to the robot 420b (e.g., via controller 470) as the fluid level changes over time so that the robot can adjust how far to dip the wire-holding fixture into the container 810. Other fluid monitors that may be used instead of a camera are, for example, an ultrasonic level transmitter, a laser level transmitter, a float level transmitter, or other types of sensors. For any of these fluid monitors, the fluid monitor 480 can be in communication with the dipping mechanism (e.g., robot 420b), via the controller or computer processor (e.g., controller 470), to provide feedback on the location of the fluid surface. In some aspects, the controller 470 is configured to control a motion of the robot (e.g., robot 420b) for dipping the working wire 10 into the container 810 based on the fluid level tracked by the fluid monitor 480. During dipping cycles, the robot may position the wire-holding fixture 415 at a certain location relative to the rim of container 810 for a certain fluid level of the dipping solution 840. As the fluid level decreases (is lower in the container 810) over time, as determined by the fluid monitor 480, the controller 470 instructs the robot to position the wire-holding fixture 415 at a different position relative to the rim of container 810 (e.g., farther into the container 810) when beginning its dipping insertion or withdrawal so that the working wires are fully and properly dipped.

In some aspects, the controller (e.g., controller 470) is advantageously configured to instruct control box 825 to turn off stirring of the dipping solution performed by the hot plate/stir plate 820 when working wires are being dipped and to turn on stirring between dipping cycles. In this manner, the dipping solution is approximately stationary during dipping of the working wires. When working wires 10 are not being dipped, stirring keeps polymers, water, solvent, and/or other components of the dipping solution uniformly mixed in preparation for the next working wires to be dipped.

When the dipping solution 840 is stationary or still, a skin can form on the top surface of the solution. In some aspects, the fluid monitor 480 visually monitors a condition of the surface of the dipping solution to prevent skinning. In response to images provided by fluid monitor 480, the control box 825 determines (directly or via a controller, e.g., controller 470) a stirring rate of the hot plate/stir plate 820. The fluid monitor 480 may be a camera in communication with a controller (e.g., control box 825 or controller 470) that is configured to identify a change in the surface of the dipping solution, such as by a change in reflectivity or other property that may indicate that the surface is skinning. For example, the controller may detect (from images from the fluid monitor) that the surface of the dipping solution is becoming flat or less reflective, indicating that a skin is forming or has formed on the surface. When skinning is occurring or has occurred, the fluid monitor 480 may be in communication with the hot plate/stir plate 820 to control a stirring rate (e.g., revolutions per minute “RPM”). The controller may use images from fluid monitor 480 detect fluid motion or fluid dynamics during stirring to set the RPM accordingly, such as to create enough of a vortex in the dipping solution to refresh the surface, but not too high of an RPM as to accelerate evaporation of water or solvent in the dipping solution. This visual monitoring of the surface of the dipping solution and of the stirring motion itself to control stirring rates, using images from the fluid monitor 480, provides various benefits such as improving the quality of dipping (e.g., by preventing skinning) and prolonging the life of the dipping solution (e.g., by stirring at an appropriate rate to prevent over-evaporation).

In some examples, the robot (e.g., robot 420b) moves wire-holding fixtures to and from the conveyor 430 and also performs the dipping. In other aspects, the dipping may be performed by a separate mechanism (e.g., a linear stage, lead screw, or other mechanism), and the robot moves the fixture from the conveyor to the dipping mechanism. The separate mechanism (e.g., a motor of the linear stage of lead screw) may also be in communication with the controller 470 of system 400 to perform the appropriate dipping parameters (e.g., withdrawal speed based on diameters measured by an optical measurement tool).

In some aspects, a system for coating a working wire of a metabolic sensor includes a dipping station having a container and a fluid monitoring device, wherein the fluid monitoring device is positioned to detect a fluid level of a dipping solution in the container. A robot is positioned to dip a working wire into the dipping solution. A controller is in communication with the dipping station and the robot, wherein the controller is configured to control a depth of dipping the working wire into the dipping solution based on the fluid level. The system may further comprise an optical measurement tool configured to measure a diameter of the working wire; wherein the controller is further configured to control a withdrawal speed of the working wire from the dipping solution based on the diameter measured by the optical measurement tool.

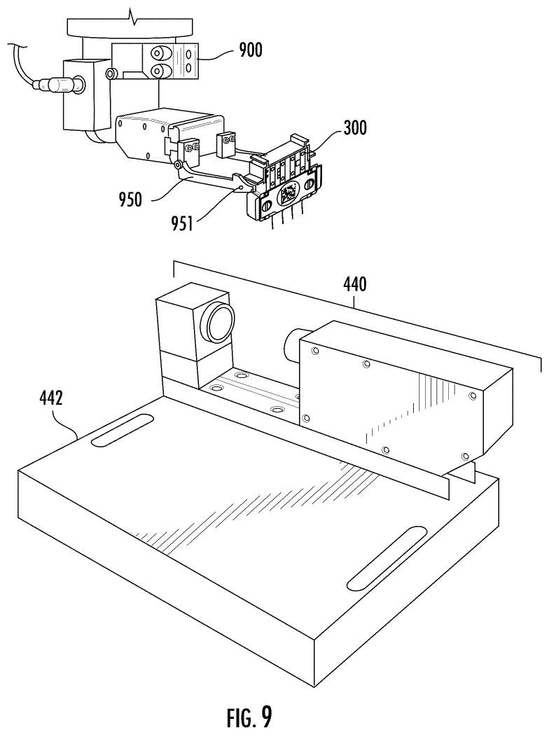

FIG. 9 is a perspective view of an optical measurement tool 440 that may be used in the present systems and methods, in accordance with some aspects. The in-line optical measurement tool 440 serves as an automated measurement system during the manufacturing process, where the diameter of each work-in-progress (WIP) wire is measured to derive a coating thickness that has accumulated from the last dipping cycle. The optical measurement tool 440 may be, for example, an optical micrometer that utilizes a laser beam to measure dimensions in a non-contact manner. The laser micrometer detects the size of the WIP wire by measuring the shadow of the object that is within the path of the laser beam. The optical measurement tool 440 may be mounted on a stage 442 that has both linear and rotational actuators, which enables the optical measurement tool 440 to be moved so that it can measure the WIP wires on the wire-holding fixture from various angles and at various points along the length of the WIP wires.

A robot 900 with jaws 950 may be utilized to move the wire-holding fixture 300 (as described in FIGS. 3A-3B) while the WIP wires are being scanned by the optical measurement tool 440. In either case (whether the optical measurement tool 440 moves or the robot 900 moves the WIP wires), each WIP wire in the wire-holding fixture 300 may have its thickness measured along its entire length and at different angles around its entire circumference. In this way, thickness is defined for every WIP wire at each dip for both length and angular rotation. Measurements can be made at more than one location along a length of the WIP wire, and the wire-holding fixture 300 can be rotated around a longitudinal axis of the WIP wire so that the diameters are measured again along their length from a different orientation. In an example, each WIP wire can be measured at 10 to 40 points along its length, and from three different angles at each point. When the WIP wires have been measured as achieving the desired total coated membrane thickness, within an acceptable target window, the WIP wires are unloaded, such as being placed in the staging area 410.

As seen in FIG. 9, robot 900 may have jaws 950 that are uniquely designed to hold the wire-holding fixture 300. For example, jaws 950 may have gripper ends 951 shaped to fit into recess 319 on the sides of wire-holding fixture 300 (FIGS. 3A-3B). In one example, the jaws 950 may be apart when not holding the wire-holding fixture 300, then move toward each other to grip the lateral sides of the wire-holding fixture 300.

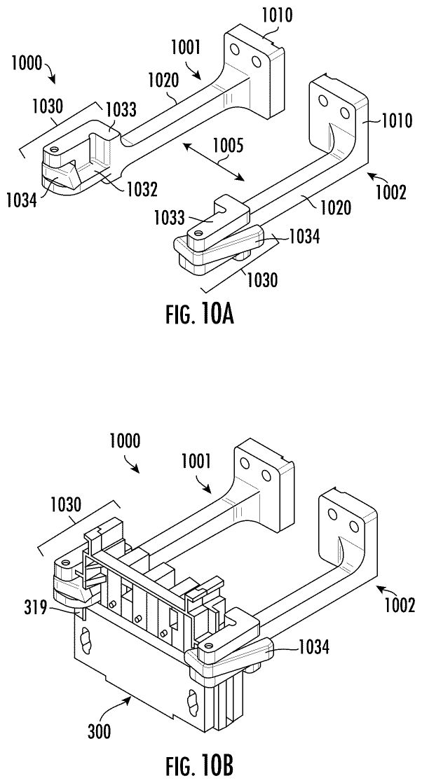

FIGS. 10A-10B are views of another configuration of jaws 1000, in accordance with some aspects. FIG. 10A is a perspective view of the jaws 1000 alone, and FIG. 10B is a perspective view of the jaws 1000 holding the wire-holding fixture 300. Jaws 1000 includes individual jaws 1001 and 1002 that are mirror images of each other, each having a base 1010 to mount it to a robot, an arm 1020 extending from the base 1010, and a gripping area 1030. The gripping area 1030 has a ledge 1032 and an arm 1034 pivotally connected to the end of the gripping area 1030. The arm 1034 is L-shaped in this example, pivoting at the corner of its L-shape on the end of gripping area 1030.

The robot is configured to move jaw 1001 and jaw 1002 toward or away from each other as indicated by arrow 1005. Jaws 1001 and 1002 are at a distance apart that is wider than the wire-holding fixture 300 when moving into position to grab the wire-holding fixture. To grasp the wire-holding fixture 300, the jaws 1001 and 1002 are moved toward each other until they contact lateral sides of the wire-holding fixture 300 as shown in FIG. 10B, such that recess 319 (details in FIG. 3B) of the wire-holding fixture 300 is seated in the gripping area 1030 (e.g., with an upper edge of the recess 319 seated on ledge 1032). In this example, the robot comprises a jaw (jaws 1001, 1002) having an arm 1034 that is spring-loaded and pivotally coupled to an end (gripping area 1030) of the jaw. The arms 1034 are biased (e.g., spring-loaded) to push the wire-holding fixture 300 toward the opposite jaw. In this manner, the arms 1034 beneficially self-center the wire-holding fixture 300 in the jaws 1000 (e.g., through spring-loaded pivoting action in this example). The spring-loading also helps orient the wire-holding fixture 300 vertically, such as by pushing the wire-holding fixture 300 against the vertical side walls 1033 of the gripping area 1030. Having the wire-holding fixture 300 positioned vertically helps ensure that working wires in the wire-holding fixture 300 will be perpendicular to the dipping solution when dipped, so that the resulting dip coating will be uniform around the circumference of the working wires.

As described in U.S. Pat. No. 12,087,469, the present systems and methods adjust dipping parameters based on the measured thicknesses and on other factors that are monitored during dipping such as the temperature or viscosity of the coating solution. In some aspects, environmental factors can also be analyzed along with the coated wire measurements to adjust dipping parameters. In further aspects, coating solutions of different viscosities can be provided for the dipping process, and the system can choose which viscosity to use based on the measurements. The systems and methods may optimize the manufacturing process, such as by reducing the number of dips required to achieve a desired coating thickness within a target window.

In one example, for the initial dip for the wire-holding fixture 415, the robot 420b may perform the dip according to a wire plan, as instructed by controller 470. For subsequent dips in a sequence of multiple dips for the wire-holding fixture 415, the robot 420b will perform the dip according to the wire plan along with applying adjustments made by the controller 470. Thicknesses of the coating layers are measured as an in-line process—that is, as the working wires 10 progress through the dipping process—and dipping parameters are adjusted as needed to achieve the required thicknesses within a target window of a thickness setpoint and/or within a predefined number of dips. For example, a total thickness of a membrane (e.g., enzyme membrane 122 or glucose limiting membrane 123) may be desired to be 4 microns to 25 microns, such as 6 microns to 19 microns, where multiple coating layers are applied to form the total thickness. A target window for a desired setpoint thickness may be, for example, ±1 to ±3 microns, such as ±2 microns, of the setpoint thickness.

Following the measurement of thickness by the optical measurement tool, an algorithm compares that measurement (e.g., per an aggregate criteria such as an average or a median) to a thickness setpoint and determines the difference. If the total thickness of the working wire 10 is within an acceptable range of the target dimension, the dipping process is completed. If the target thickness has not been achieved, the algorithm then decides whether to alter one or more dipping parameters. The algorithm may alter the withdrawal speed based upon the remaining thickness that needs to be achieved and based upon a viscosity of the coating solution. Since viscosity can change during the process due to solvent evaporation, an in-line viscometer can be used to measure the viscosity, or a fixed time versus solvent loss relationship may be used to estimate the new viscosity. For example, the algorithm may optionally project a new viscosity of the solution according to an amount of time that has elapsed since the initial viscosity was input. The new viscosity may account for environmental conditions (e.g., from environmental sensors of FIG. 2). In this manner, the algorithm can shift the withdrawal vs. thickness curves used based upon viscosity.

The algorithm chooses a withdrawal speed utilizing a series of withdrawal speeds versus thickness curves that are created for ranges of potential viscosities. The range of viscosities may represent changing values of the viscosity of the coating solution over time, and/or may represent separate tubs of coating solutions with different viscosities that are available for the dipping process. The algorithm can use other forms of correlations rather than a correlation curve, such as a mathematical equation or a data table.

Implementations of the present disclosure include adjusting parameters based on aspects other than or in addition to withdrawal speed, viscosity and thickness as described herein. In some cases, methods include dipping the plurality of wires using the adjusted parameters based on the thickness difference. In some cases, calculating the adjusted parameters is further based on environmental factors, where the environmental factors comprise, for example, an airflow and a relative humidity of the airflow. In some cases, calculating the adjusted parameters comprises referring to a set of correlations. Each correlation in the set of correlations may involve, for example, layer thickness as a function of withdrawal speed for a given viscosity of the coating solution. Some cases include determining the viscosity of the coating solution and choosing a correlation in the set of correlations based on the viscosity. Determining the viscosity may include measuring the viscosity of the coating solution or estimating a viscosity of the coating solution based on a relationship of solvent loss over time for the coating solution.

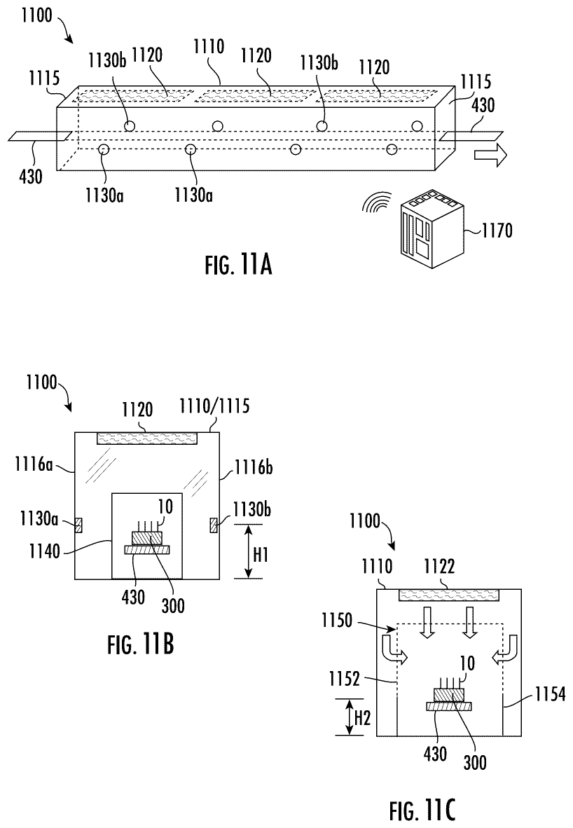

FIG. 11A shows a side isometric view of a heater 1100 for curing working wires, in accordance with some aspects. The heater 1100 in this example is a heat tunnel having an enclosure 1110 with ends 1115 through which conveyor 430 enters and exits. A plurality of heating sources 1120 are along the length of the heater 1100, such as located in the interior of the ceiling of the heater 1100 in this example. Types of heating sources 1120 that may be used for the heater 1100 include, for example, resistive heating and radiant heating. Also included in the interior side walls of the heater 1100 are a plurality of temperatures sensors 1130a-b (e.g., thermocouples). In this example, temperature sensors 1130a are on a first side wall 1116a and temperatures sensors 1130b are on an opposite side wall 1116b (FIG. 11B). The temperature sensors 1130a-b are beneficially located at a height “H1” along the side walls 1116a-b near the path of the conveyor 430 (e.g., where the working wires 10 will pass), rather than at the ceiling of the heater 1100 next to the heating sources 1120 as in conventional heat tunnels. By being located on the side walls near the conveyor 430, temperature sensors 1130a-b more accurately monitor the temperatures that are experienced by working wires on the conveyor than if the temperature sensors were located at the ceiling.

Having a plurality of heating sources 1120 and a plurality of temperature sensors 1130a-b distributed along the length of the heater 1100 provides more controlled heating along the heater 1100 than having a single heater and temperature sensor as in conventional heat tunnels. In some examples, the plurality of heating sources 1120 and temperature sensors 1130a-b are distributed at approximately even distances along the length of the heater 1100. In some cases, the heating sources 1120 may be controlled individually based on temperature measurements from temperature sensors 1130a-b located nearest to each heating source (e.g., centered with the heating source, or at each end). In some cases, the heating sources 1120 may be controlled based on temperature measurements from local and downstream temperature sensors 1130a-b. In some examples, the heating sources 1120 may be controlled by a controller 1170 of the heater 1100. In other examples, the heating sources 1120 may be controlled by a controller of the overall dipping system (e.g., controller 470 of FIG. 4).

The ends 1115 of the heater 1100 may be open-ended in some cases (i.e., no wall or panel covering a portion of the ends 1115). In other cases, as shown in the end view of FIG. 11B (which may be either end of the heater 1100), ends 1115 may have a wall (e.g., end cap) with an opening 1140 sized for the conveyor 430 and working wires 10 on wire-holding fixtures 300 to pass through. Having the ends 1115 enclosed can facilitate achieving the desired curing temperature inside the heater 1100 near the ends 1115, rather than having some heat loss with no walls on ends 1115.

FIG. 11C is a cross-sectional view at a central portion of heater 1100, in accordance with some aspects. In this example, a heating unit 1122 may include both a heating source and a fan to help distribute heat. The fan may be between the heating source and the ceiling of the enclosure 1110, or the heating source may be between the fan and ceiling. A baffle 1150 may be included within the enclosure 1110, forming a sub-enclosure or sub-tunnel within the heater 1100, through which the conveyor 430 passes. In this example, the baffle 1150 is partially vented, such as having perforations or apertures in a top portion 1152 of its walls above height H2. The bottom portion 1154 of the walls of the baffle 1150 are solid below height H2. Height H2 may be, for example, approximately at the height of the conveyor 430 or the wire-holding fixture 300. Heated air from heating unit 1122 is distributed around the working wires 10, through the vented top portions 1152 of the baffle 1150, to cure the coating on the working wires. Air from below the conveyor 430 is blocked by the bottom portion 1154 of the walls and not circulated upward, to prevent particles below the conveyor 430 (e.g., grease, dust) from contaminating the working wires 10.

The speed of the conveyor 430 through the heater (e.g., heater 460 or 1100) can be adjusted to provide the proper curing time for the working wires. For example, the system may be configured to provide a heating time of 10 minutes to 30 minutes, such as 20 minutes in the heater. The curing time in the heater can be controlled by the conveyor speed as it passes through or along the heater. In some aspects, a controller (e.g., controller 470) is configured to control a conveyor speed of the conveyor based on a curing time for the working wire. For example, to increase the curing time, the controller may run the conveyor at a slower speed so that the working wires have a longer dwell time in the heater 1100. To decrease the curing time, the controller may run the conveyor at a faster speed so that the working wires have a shorter dwell time in the heater 1100.

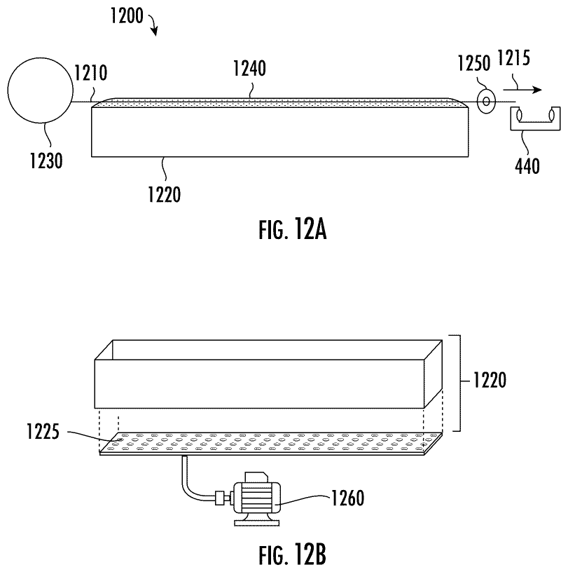

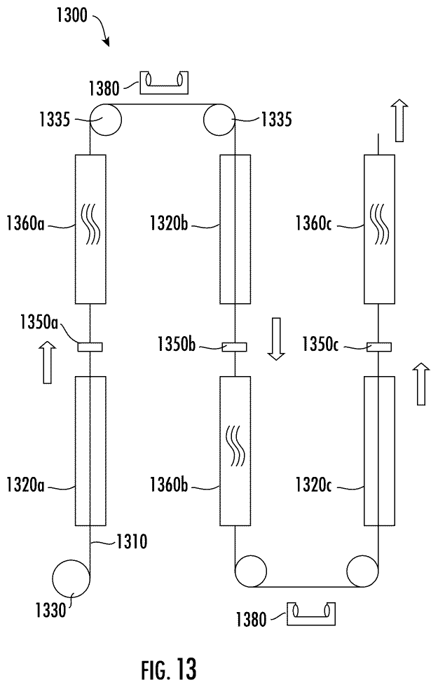

FIGS. 12A-12B describe aspects in which a system for dip coating a working wire for a biological monitor (e.g., a glucose sensor or a lactate sensor) may be configured for continuous manufacturing. Continuous manufacturing may involve processing the working wire as a continuous length (e.g., fed from a spool) rather than processing individual pieces of wire that are pre-cut to discrete lengths. FIG. 12A is a longitudinal side view of a dipping station 1200 having a dipping container 1220 (e.g., tank or trough) that may be utilized for a continuous manufacturing dipping process, in accordance with some implementations. In this example, a working wire 1210 to be coated is fed from a spool 1230 (or other continuous feed wire source) that is located either directly before the dipping container 1220 or further upstream in the manufacturing process. The dipping container 1220 is a horizontal tank filled with dipping solution 1240 such that the dipping solution 1240 forms a meniscus that is slightly above the walls of the dipping container 1220. The height of the meniscus is scaled up in this figure for illustrative purposes. The working wire 1210 is pulled horizontally (i.e., fed) through the meniscus (i.e., top surface) of the dipping solution 1240, as indicated by arrow 1215, to perform the dipping process. The pulling speed, which serves as the dipping and withdrawal speed in vertical dipping processes, can be adjusted based on feedback on other parameters as described herein, such as the coating thickness of previously applied layers, viscosity of the dipping solution, and/or environmental factors (e.g., temperature and/or humidity). After being coated with the dipping solution 1240, the working wire 1210 can optionally be pulled through a die 1250, where the size of the die 1250 (i.e., a hole in the die through which the working wire is passed) can be used to remove excess coating (dipping solution 1240) while the coating is still wet, and/or to control the thickness and/or concentricity of the coating on the working wire. The speed of the working wire 1210 through the dipping container 1220 can be controlled or adjusted according to diameter measurements (corresponding to coating thickness) taken by an optical measurement tool between dipping cycles. The die 1250 may be between the optical measurement tool (e.g., optical measurement tool 440) and an exit end of the dipping container 1220. After dipping, the coated working wire 1210 can be cured and cut to length as needed.

FIG. 12B shows an exploded view of the dipping container 1220, along with a pump 1260 in accordance with some aspects. To create the meniscus of the dipping solution 1240 in this implementation, pump 1260 is coupled to the dipping container 1220 to fill the dipping container with dipping solution, causing an “overflow” condition such that the meniscus is formed at the top surface of the dipping solution. In this example, the dipping container 1220 comprises a perforated bottom plate 1225 through which the dipping solution is supplied from the pump 1260 to the dipping container. The pump 1260 provides pressure and/or fluid through the perforated bottom plate 1225 of the dipping container 1220. The perforated bottom plate 1225 promotes laminar flow of the fluid (i.e., dipping solution 1240), which creates a uniform level of the dipping solution 1240 for the working wire 1210 to be pulled through. In contrast, turbulent flow may cause unwanted waves in the dipping solution 1240, which may result in the meniscus being higher or lower at various points along the fluid's surface. This uneven surface may result in uneven coating of the working wire 1210.

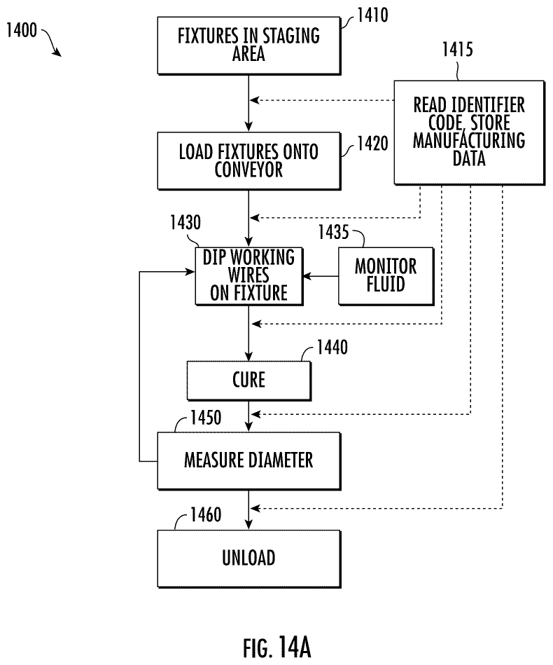

FIG. 13 is a schematic plan view of a manufacturing system 1300 for performing dip coating of a working wire in a continuous manner, in accordance with some aspects. The process starts at the bottom left of the figure, with working wire 1310 being fed from a spool 1330 (or from a previous manufacturing operation, such as a previous operation of forming of an interference membrane if the dip coating of FIG. 13 is for an enzyme membrane). The working wire 1310 is fed through a first dipping container 1320a (e.g., a bath, tub, trough), and optionally through a die 1350a to remove excess dipping solution and/or to adjust the coating thickness on the working wire. The dipping container 1320a may have a meniscus as described in FIGS. 12A-12B to provide a dipping surface for the working wire 1310 to pass through, thus performing the dipping. The coating applied by dipping container 1320a is cured by passing the wire through heater 1360a. Heater 1360a may be, for example, the heater 1100 of FIGS. 11A-11B. The diameter of the coated working wire may be measured with optical measurement tool 1380 after being cured in heater 1360a. The working wire 1310 may traverse around one or more spools 1335 after being cured, where the spool 1335 may be or may include a pulley and/or wheel. In some cases, a pulley or wheel can be used to change the direction of the working wire, and a spool may be used to take up slack, such as to account for differences in traveling speed of the working wire 1310 as it moves through the different components in the system 1300. For instance, slack can be built into the line to enable the working wire 1310 to speed up at times (e.g., to move the working wire faster for dipping).

The working wire 1310 then enters a second dipping cycle at dipping container 1320b and a second curing chamber (heater 1360b), optionally with another die 1350b between the dipping container 1320b and heater 1360b to remove excess dipping solution and/or adjust the coating thickness before the second coating layer is cured. Die 1350b may have a different size opening for the working wire 1310 to be pulled through than die 1350a, according to the desired coating thickness at that stage. The working wire 1310 continues through an alternating series of dipping and heating (e.g., dipping container 1320c, heater 1360c, and optional die 1350c) until the final total membrane thickness is achieved. In some examples, three to five dipping containers may be utilized sequentially to achieve a desired total membrane thickness. Although a serpentine layout of the dipping containers and heaters are shown in this example, other configurations are possible such as a linear path, a rectangular path, or combinations and variations of these. In another example, a working wire may traverse a closed loop path involving being re-dipped in one or more dipping container. For example, the system 1300 may only include two sets of dipping containers and heaters, and the wire may be dipped in dipping container 1320a, then dipping container 1320b, then dipping container 1320a again.

In dipping station 1200 and manufacturing system 1300, the different dipping baths (containers) may have dipping solutions with different viscosities, such as to compensate for a desired speed of pulling (dipping) the working wire through the baths or to achieve different coating thicknesses. Optical measurement tools 1380, as described throughout this disclosure, may be included in dipping station 1200 and manufacturing system 1300 to take measurements after one or more of the dipping stages. The optical measurement tools 1380 can monitor the coating thicknesses being deposited, where the measured diameters may be used to as feedback to determine a dipping parameter for the dipping stations, such as to adjust the dipping or withdrawal speed. Motors and tensioning mechanisms are not shown but may be included along the dipping path of FIGS. 12A-12B and 13 to pull the working wire along and to ensure that the coated wire does not sag, which could damage the working wires due to contact with manufacturing equipment (e.g., walls of the dipping container or heater).

In some aspects, a system for coating a working wire of a metabolic sensor includes a dipping container shaped as a horizontal tank and configured and to hold a dipping solution; a continuous feed wire source positioned to feed a working wire across a top surface of the dipping solution; and an optical measurement tool configured to measure a diameter of the working wire after exiting the dipping container.

In some aspects, the system may include a die between the optical measurement tool and an exit end of the dipping container, the die having a hole through which the working wire is passed. In some aspects, the system may include a controller configured to control a speed of the working wire through the dipping container. In some aspects, the system may include a pump coupled to the dipping container, the pump configured to fill the dipping container with the dipping solution, thereby create a meniscus at the top surface of the dipping solution for the working wire to be fed through. In some aspects, the dipping container comprises a perforated bottom plate through which the dipping solution is supplied from the pump to the dipping container. In some aspects, the system may include a heater between the optical measurement tool and an exit end of the dipping container. In some aspects, the system may include a second dipping container and a second heater downstream from the heater.

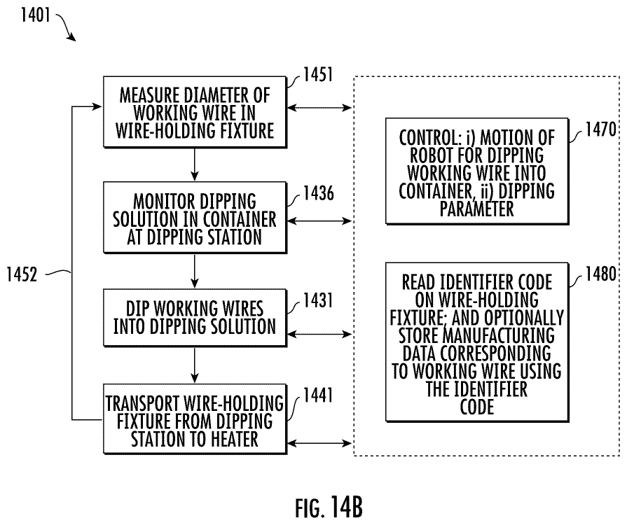

FIG. 14A is a flowchart of an example method 1400 of dip coating a working wire, such as for a biological sensor (e.g., a metabolic sensor, a glucose sensor, a lactate sensor) using the systems described herein (e.g., system 400). The particular steps, order of steps, and combination of steps are shown for illustrative and explanatory purposes only. Other examples can implement different particular steps, orders of steps, and combinations of steps to achieve similar functions or results.

In block 1410, wire-holding fixtures that have working wires (e.g., wire-loading fixtures 300, 415) loaded into them are stored in a staging area. In block 1420, a robot (e.g., robot 420a) takes wire-holding fixtures from the staging area and moves them to a conveyor (e.g., conveyor 430). Block 1415 involves reading, using a reader 425a-b, an identifier code (e.g., identifier code 304) on the wire-holding fixture, and storing, on a computer processor, manufacturing data corresponding to the working wire associated with the identifier code. Block 1415 may be performed at various times during the method 1400 by one or more readers (i.e., reading devices) to track progress of working wires on the wire-holding fixture. For example, the reader may be an optical device such as a camera which scans each wire-holding fixture's identifier code (e.g., a QR code) and sends information to a computer processor to track the fixture's progress. The computer processor or controller may record the time the wire-holding fixture with the working wires was moved and track location of the wire-holding fixture. The parameters for that dipping (i.e., coating) cycle of the working wires may also be recorded.

In block 1430, a wire-holding fixture is put in a dipping station (e.g., dipping stations 450, 800) and working wires in the wire-holding fixture are dip coated. For example, the dipping may be an aqueous solution to form an enzyme layer of a glucose sensor or a lactate sensor. In any of the dipping stations described herein, the wire-holding fixtures may be held by a robot (e.g., robot 420b) with the working wires extending downward from the wire-holding fixture, to be dipped into the dipping container. The robot may perform the dipping motion into the dipping solution or may load the wire-holding fixture into a separate mechanism that performs the dipping as described above. In some cases, more than one wire-holding fixture may be dipped at a time, such as with two wire-holding fixtures snapped together as described in relation to FIGS. 3A-3B. In some aspects, a controller is configured to control a dipping parameter, such a withdrawal speed for the robot moving the working wire out of the dipping solution.

Block 1435 involves monitoring, by a fluid monitoring device (e.g., fluid monitor 480, which may be an optical device), the dipping solution in a container of a dipping station. In some aspects, the fluid monitoring device may monitor a fluid level of the dipping solution, and block 1435 may involve controlling, by a controller, a motion of the robot for dipping the working wire into the dipping solution based on the fluid level. For example, the controller may control a range of motion of the robot (i.e., distance the robot moves the wire-holding fixture into the dipping container) for dipping the working wire into the container based on the fluid level. In another example, block 1435 may involve controlling, by a controller, a position (i.e., location relative to the dipping container) at which the robot begins its insertion or withdrawal speed for dipping the working wire into the container, based on the fluid level. In some implementations of block 1435, the dipping station comprises a lid on the container and an actuator operatively coupled to the lid; and the controller is configured to actuate the actuator to move the lid between a closed position and an open position, the lid being in the closed position when the dipping station is not in use. In some implementations of block 1435, the dipping station comprises a stir plate below the container, wherein the controller is configured to control a stirring rate of the stir plate. For example, fluid monitoring device may be a camera, and the controller may use images from the camera to control the stirring rate of the stir plate.

In block 1440, the coatings on the working wires are cured. The wire-holding fixtures may be placed on the conveyor to move the working wires through the heater, in some examples. That is, the wire-holding fixtures may be transported from the dipping station to a heater (e.g., heater 1100) by a conveyor. In some implementations, the heater is a heat tunnel through which the conveyor passes. The heat tunnel may include a plurality of temperature sensors along the length of the heat tunnel and located on a side wall of the heat tunnel at a height corresponding to a location of the conveyor. The heat tunnel may include an end wall at an end of the heat tunnel, the end wall having an opening for the conveyor to pass through. In some examples, the conveyor forms a continuous loop between the dipping station and the heater. In some examples, a controller is configured to a conveyor speed of the conveyor, where the conveyor speed may be based on a curing time for the working wire.

In block 1450, diameters of the coated working wires may be measured to determine if further dipping is needed and/or to adjust the dipping parameters to be used on the next dip. Block 1450 may involve measuring, by an optical measurement tool, a diameter of a working wire in a wire-holding fixture. The dipping, curing, and measuring of blocks 1430, 1440, 1450, respectively, may be repeated until the desired total membrane layer thickness is reached. In block 1460, after the desired coating thicknesses have been fabricated, the wire-holding fixtures are unloaded and placed back into the staging area or moved to the next manufacturing process station.

FIG. 14B is a flowchart of another method 1401 for dip coating a working wire (e.g., a sensor wire for a metabolic sensor), in accordance with some aspects. The particular steps, order of steps, and combination of steps are shown for illustrative and explanatory purposes only. Other examples can implement different particular steps, orders of steps, and combinations of steps to achieve similar functions or results.

Method 1401 describes interactions between various stations and components of the system during the dip coating. Description of processes such as measuring, dipping, and curing from FIG. 14A apply to FIG. 14B. Block 1451 (equivalent to block 1450) involves measuring, by an optical measurement tool (e.g., optical measurement tool 440), a diameter of a working wire in a wire-holding fixture. If the dipping cycle is the first layer being coated onto the working wire, block 1451 may be omitted until before the next dipping cycle as indicated by loop 1452. Loop 1452 may involve heating, by the heater, the working wire to cure the working wire; and repeating the measuring the diameter of the working wire after the heating.

Block 1436 (equivalent to block 1435) involves monitoring, by a fluid monitoring device (e.g., fluid monitor 480), a dipping solution in a container of a dipping station (e.g., dipping stations 450, 800). The monitoring may involve monitoring a fluid level of the dipping solution. Block 1431 (equivalent to block 1430) involves dipping, by a robot, the working wire into the dipping solution. In block 1441, a conveyor transports the wire-holding fixture from the dipping station to a heater for curing the dipped (i.e., coated) working wires. The curing of block 1440 in FIG. 14A may then be performed.

Block 1470 involves controlling, by a controller (e.g., controller 470) at least one of: i) a motion of the robot for dipping the working wire into the container based on the fluid level monitored in block 1436 (e.g., a position of the robot relative to the dipping container for performing the dipping motion), and ii) a dipping parameter based on the diameter measured by the optical measurement tool in block 1451. Block 1470 may also involve controlling iii) a conveyor speed of the conveyor. The dipping parameter may be, for example, a withdrawal speed for the robot moving (i.e., extracting) the working wire out of the dipping solution.

In some implementations, the robot of block 1431 is positioned to move the wire-holding fixture between the conveyor, the optical measurement tool, and the dipping station. At any of blocks 1431, 1436, 1441, and 1451, some implementations may include block 1480 of reading, using a reader, an identifier code on the wire-holding fixture; and optionally storing, on a computer processor, manufacturing data corresponding to the working wire using the identifier code.

In some aspects, block 1470 may include actuating, by the controller, an actuator operatively coupled to a lid on the container, to move the lid between a closed position and an open position, the lid being in the closed position when the dipping station is not in use. In some aspects, block 1470 may include controlling, by the controller, a stirring rate of a stirring plate below the container based on images from the fluid monitoring device. In some aspects, block 1470 may include controlling, by the controller, a conveyor speed of the conveyor based on a curing time for the working wire.

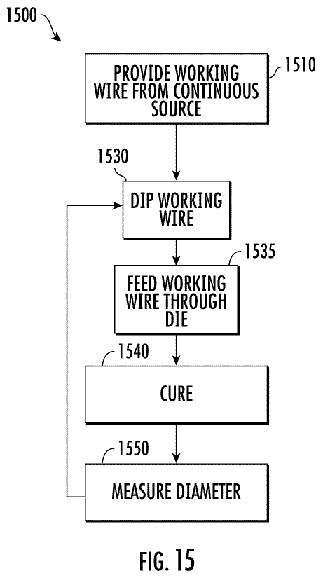

FIG. 15 is a flowchart of a method 1500 for dip coating of a working wire in a continuous manner, in accordance with some aspects. The particular steps, order of steps, and combination of steps are shown for illustrative and explanatory purposes only. Other examples can implement different particular steps, orders of steps, and combinations of steps to achieve similar functions or results.

The method 1500 may be performed, for example, using the systems of FIGS. 12A-12B and/or FIG. 13. In block 1510, a working wire is provided on a spool or other continuous wire source. The wire may be uncoated if the dipping is the first layer to be coated on the wire, or the wire may be coated with previous layers. In block 1530, the working wire is dipped by being fed across a top surface (e.g., through a meniscus) of a dipping solution in a dipping container. The dipping container may be, for example, a trough or bath, and optionally may include a pump to supply the dipping solution (e.g., through a perforated bottom plate of the dipping container). Optionally, the working wire may be passed through a die in block 1535 after the dipping, to remove excess dipping solution and/or to adjust the coating thickness or concentricity on the working wire. In block 1540, the coating is cured on the working wire by passing the working wire through a heater, such as a heat tunnel. In block 1550, the diameter of the working wire may be measured along the length of the continuous wire by an optical measurement tool. Blocks 1530, 1535, 1540 and 1550 may be repeated by running the working wire again through the same dipping, curing, and measurement stations, or through a series of dipping, curing, and measurement stations as described in FIG. 13.

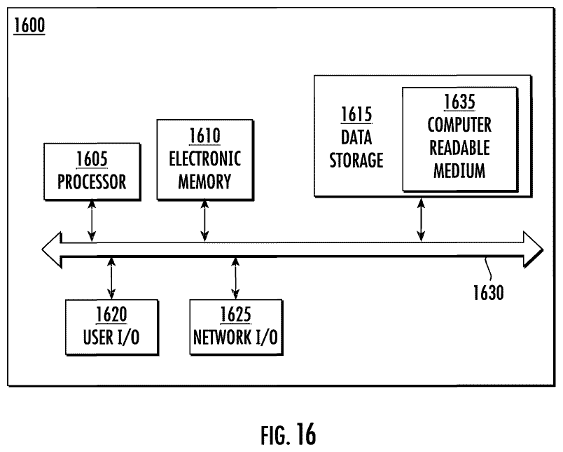

FIG. 16 is a simplified schematic diagram showing an example computer processor 1600 for use in the controllers of the methods and systems, in accordance with some aspects. Other implementations may use other components and combinations of components. For example, the computer processor 1600 may represent one or more physical computer devices or servers, such as web servers, rack-mounted computers, network storage devices, desktop computers, laptop/notebook computers, etc., depending on the complexity. In some cases implemented at least partially in a cloud network potentially with data synchronized across multiple geolocations, the computer processor 1600 may be referred to as one or more cloud servers. In some aspects, the functions of the computer processor 1600 are enabled in a single computer device. In more complex implementations, some of the functions of the computing system are distributed across multiple computer devices, whether within a single server farm facility or multiple physical locations. In some aspects, the computer processor 1600 functions as a single virtual machine.

In this illustration, the computer processor 1600 generally includes at least one processor 1605, a main electronic memory 1610, a data storage 1615, a user input/output (I/O) 1620, and a network I/O 1625, among other components not shown for simplicity, connected or coupled together by a data communication subsystem 1630. A non-transitory computer readable medium 1635 includes instructions that, when executed by the processor 1605, cause the processor 1605 to perform operations including calculations and methods as described herein.

In accordance with the description herein, the various components of the system or method generally represent appropriate hardware and software components for providing the described resources and performing the described functions. The hardware generally includes any appropriate number and combination of computing devices, network communication devices, and peripheral components connected together, including various processors, computer memory (including transitory and non-transitory media), input/output devices, user interface devices, communication adapters, communication channels, etc. The software generally includes any appropriate number and combination of conventional and specially-developed software with computer-readable instructions stored by the computer memory in non-transitory computer-readable or machine-readable media and executed by the various processors to perform the functions described herein.

As described herein, the present systems and processes enable coating of a working wire of a biological sensor, such as a glucose sensor or a lactate sensor, to be performed in an automated fashion with high accuracy and trackability.

Example aspects of the present systems and methods are described in the clauses below.

### CLAUSES

Clause 1. A system for dip coating a working wire of a metabolic sensor, comprising: an optical measurement tool configured to measure a diameter of a working wire in a wire-holding fixture; a dipping station having a container and a fluid monitoring device, wherein the fluid monitoring device is positioned to detect a fluid level of a dipping solution in the container; a heater; a conveyor between the dipping station and the heater; a robot positioned to move the wire-holding fixture between the conveyor, the optical measurement tool and the dipping station, the robot being configured to dip the working wire into the dipping solution; and a controller in communication with the dipping station and the robot, wherein the controller is configured to control i) a motion of the robot for dipping the working wire into the container based on the fluid level and ii) a dipping parameter based on the diameter measured by the optical measurement tool.

Clause 2. The system of clause 1, wherein the metabolic sensor is a continuous glucose monitor.

Clause 3. The system of any of clauses 1-2, further comprising a reader positioned to read an identifier code on the wire-holding fixture, the reader in communication with a computer processor that stores manufacturing data corresponding to the working wire associated with the identifier code.

Clause 4. The system of any of clauses 1-3, wherein the fluid monitoring device is an optical device.

Clause 5. The system of any of clauses 1-4, wherein the dipping station further comprises a lid on the container and an actuator operatively coupled to the lid; wherein the controller is configured to actuate the actuator to move the lid between a closed position and an open position, the lid being in the closed position when the dipping station is not in use.

Clause 6. The system of any of clauses 1-5, wherein the dipping station further comprises a stir plate below the container, wherein the controller is configured to control a stirring rate of the stir plate.

Clause 7. The system of clause 6, wherein the fluid monitoring device is a camera, and the controller uses images from the camera to control the stirring rate of the stir plate.

Clause 8. The system of any of clauses 1-7, wherein the heater is a heat tunnel through which the conveyor passes, the heat tunnel comprising: a plurality of temperature sensors along a length of the heat tunnel and located on a side wall of the heat tunnel at a height corresponding to a location of the conveyor; and an end wall at an end of the heat tunnel, the end wall having an opening for the conveyor to pass through.

Clause 9. The system of any of clauses 1-8, wherein the conveyor forms a continuous loop between the dipping station and the heater.

Clause 10. The system of any of clauses 1-9, wherein the controller is configured to control a conveyor speed of the conveyor based on a curing time for the working wire.

Clause 11. The system of any of clauses 1-10, wherein the dipping parameter comprises a withdrawal speed for the robot moving the working wire out of the dipping solution.

Clause 12. The system of any of clauses 1-11, wherein the robot comprises a jaw having an arm that is spring-loaded and pivotally coupled to an end of the jaw.

Clause 13. A method for dip coating a working wire of a metabolic sensor, the method comprising: measuring, by an optical measurement tool, a diameter of a working wire in a wire-holding fixture; monitoring, by a fluid monitoring device, a fluid level of a dipping solution in a container of a dipping station; dipping, by a robot, the working wire into the dipping solution; transporting, by a conveyor, the wire-holding fixture from the dipping station to a heater; and controlling, by a controller: i) a motion of the robot for dipping the working wire into the container based on the fluid level, and ii) a dipping parameter based on the diameter measured by the optical measurement tool.

Clause 14. The method of clause 13, wherein the metabolic sensor is a continuous glucose monitor.

Clause 15. The method of any of clauses 13-14, wherein the robot is positioned to move the wire-holding fixture between the conveyor, the optical measurement tool, and the dipping station.

Clause 16. The method of any of clauses 13-15, further comprising: reading, using a reader, an identifier code on the wire-holding fixture; and storing, on a computer processor, manufacturing data corresponding to the working wire associated with the identifier code.

Clause 17. The method of any of clauses 13-16, further comprising actuating, by the controller, an actuator operatively coupled to a lid on the container, to move the lid between a closed position and an open position, the lid being in the closed position when the dipping station is not in use.

Clause 18. The method of any of clauses 13-17, further comprising controlling, by the controller, a stirring rate of a stirring plate below the container based on images from the fluid monitoring device.

Clause 19. The method of any of clauses 13-18, further comprising: heating, by the heater, the working wire to cure the working wire; and repeating the measuring the diameter of the working wire after the heating.

Clause 20. The method of any of clauses 13-19, further comprising controlling, by the controller, a conveyor speed of the conveyor based on a curing time for the working wire.

Clause 21. The method of any of clauses 13-20, wherein the dipping parameter comprises a withdrawal speed for the robot moving the working wire out of the dipping solution.

Clause 22. A system for dip coating a working wire of a metabolic sensor, comprising: a dipping station having a container and a fluid monitoring device, wherein the fluid monitoring device is positioned to detect a fluid level of a dipping solution in the container; a robot positioned to dip a working wire into the dipping solution; and a controller in communication with the dipping station and the robot, wherein the controller is configured to control a motion of the robot for dipping the working wire into the dipping solution based on the fluid level.

Clause 23. The system of clause 22, further comprising an optical measurement tool configured to measure a diameter of the working wire; wherein the controller is further configured to control a withdrawal speed of the working wire from the dipping solution based on the diameter measured by the optical measurement tool.

Clause 24. A system for coating a working wire of a metabolic sensor, comprising; a dipping container shaped as a horizontal tank and configured and to hold a dipping solution; a continuous feed wire source positioned to feed a working wire across a top surface of the dipping solution; and an optical measurement tool configured to measure a diameter of the working wire after exiting the dipping container.

Clause 25. The system of clause 24, further comprising a die between the optical measurement tool and an exit end of the dipping container, the die having a hole through which the working wire is passed.

Clause 26. The system of any of clauses 24-25, further comprising a controller configured to control a speed of the working wire through the dipping container.

Clause 27. The system of any of clauses 24-26, further comprising a pump coupled to the dipping container, the pump configured to fill the dipping container with the dipping solution, thereby create a meniscus at the top surface of the dipping solution for the working wire to be fed through.

Clause 28. The system of clause 27, wherein the dipping container comprises a perforated bottom plate through which the dipping solution is supplied from the pump to the dipping container.

Clause 29. The system of any of clauses 24-28, further comprising a heater between the optical measurement tool and an exit end of the dipping container.

Clause 30. The system of clause 29, further comprising a second dipping container and a second heater downstream from the heater.

In some cases, a single example may, for succinctness and/or to assist in understanding the scope of the disclosure, combine multiple features. It is to be understood that in such a case, these multiple features may be provided separately (in separate examples), or in any other suitable combination. Alternatively, where separate features are described in separate examples, these separate features may be combined into a single example unless otherwise stated or implied. This also applies to the claims which can be recombined in any combination. That is, a claim may be amended to include a feature defined in any other claim. Furthermore, a phrase referring to “at least one of” a list of items refers to any combination of those items, including single members. As an example, “at least one of: a, b, or c” is intended to cover: a, b, c, a-b, a-c, b-c, and a-b-c.

Reference has been made in detail to aspects of the disclosed invention, one or more examples of which have been illustrated in the accompanying figures. Each example has been provided by way of explanation of the present technology, not as a limitation of the present technology. In fact, while the specification has been described in detail with respect to specific aspects of the invention, it will be appreciated that those skilled in the art, upon attaining an understanding of the foregoing, may readily conceive of alterations to, variations of, and equivalents to these aspects. For instance, features illustrated or described as part of one aspect may be used with another aspect to yield a still further aspect. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A system for dip coating a working wire of a metabolic sensor, comprising:
an optical measurement tool configured to measure a diameter of a working wire in a wire-holding fixture;
a dipping station having a container and a fluid monitoring device, wherein the fluid monitoring device is positioned to detect a fluid level of a dipping solution in the container;
a heater;
a conveyor between the dipping station and the heater;
a robot positioned to move the wire-holding fixture between the conveyor, the optical measurement tool and the dipping station, the robot being configured to dip the working wire into the dipping solution; and
a controller in communication with the dipping station and the robot, wherein the controller is configured to control i) a motion of the robot for dipping the working wire into the container based on the fluid level and ii) a dipping parameter based on the diameter measured by the optical measurement tool.

2. The system of claim 1, wherein the metabolic sensor is a continuous glucose monitor.

3. The system of claim 1, further comprising a reader positioned to read an identifier code on the wire-holding fixture, the reader in communication with a computer processor that stores manufacturing data corresponding to the working wire associated with the identifier code.

4. The system of claim 1, wherein the fluid monitoring device is an optical device.

5. The system of claim 1, wherein the dipping station further comprises a lid on the container and an actuator operatively coupled to the lid;
wherein the controller is configured to actuate the actuator to move the lid between a closed position and an open position, the lid being in the closed position when the dipping station is not in use.

6. The system of claim 1, wherein the dipping station further comprises a stir plate below the container, wherein the controller is configured to control a stirring rate of the stir plate.

7. The system of claim 6, wherein the fluid monitoring device is a camera, and the controller uses images from the camera to control the stirring rate of the stir plate.

8. The system of claim 1, wherein the heater is a heat tunnel through which the conveyor passes, the heat tunnel comprising:
a plurality of temperature sensors along a length of the heat tunnel and located on a side wall of the heat tunnel at a height corresponding to a location of the conveyor; and
an end wall at an end of the heat tunnel, the end wall having an opening for the conveyor to pass through.

9. The system of claim 1, wherein the conveyor forms a continuous loop between the dipping station and the heater.

10. The system of claim 1, wherein the controller is configured to control a conveyor speed of the conveyor based on a curing time for the working wire.

11. The system of claim 1, wherein the dipping parameter comprises a withdrawal speed for the robot moving the working wire out of the dipping solution.

12. The system of claim 1, wherein the robot comprises a jaw having an arm that is spring-loaded and pivotally coupled to an end of the jaw.

13. A method for dip coating a working wire of a metabolic sensor, the method comprising:
measuring, by an optical measurement tool, a diameter of a working wire in a wire-holding fixture;
monitoring, by a fluid monitoring device, a fluid level of a dipping solution in a container of a dipping station;
dipping, by a robot, the working wire into the dipping solution;
transporting, by a conveyor, the wire-holding fixture from the dipping station to a heater; and
controlling, by a controller: i) a motion of the robot for dipping the working wire into the container based on the fluid level, and ii) a dipping parameter based on the diameter measured by the optical measurement tool.

14. The method of claim 13, wherein the metabolic sensor is a continuous glucose monitor.

15. The method of claim 13, wherein the robot is positioned to move the wire-holding fixture between the conveyor, the optical measurement tool, and the dipping station.

16. The method of claim 13, further comprising:
reading, using a reader, an identifier code on the wire-holding fixture; and
storing, on a computer processor, manufacturing data corresponding to the working wire associated with the identifier code.

17. The method of claim 13, further comprising actuating, by the controller, an actuator operatively coupled to a lid on the container, to move the lid between a closed position and an open position, the lid being in the closed position when the dipping station is not in use.

18. The method of claim 13, further comprising controlling, by the controller, a stirring rate of a stirring plate below the container based on images from the fluid monitoring device.

19. The method of claim 13, further comprising:
heating, by the heater, the working wire to cure the working wire; and
repeating the measuring the diameter of the working wire after the heating.

20. The method of claim 13, further comprising controlling, by the controller, a conveyor speed of the conveyor based on a curing time for the working wire.

21. The method of claim 13, wherein the dipping parameter comprises a withdrawal speed for the robot moving the working wire out of the dipping solution.
